(19) United States
(12) Patent Application Publication
(10) Pub. No.: US 2004/0145451 A1
(43) Pub. Date: Jul. 29, 2004

(54) Price display system and methods for use therewith

(76) Inventor: Bruce Failing, Greenwich, CT (US)

Correspondence Address: OPPEDAHL AND LARSON LLP, P O BOX 5068, DILLON, CO, 80435-5068, US

(21) Appl. No.: 10/249,707

(22) Filed: May 1, 2003

Related U.S. Application Data
(60) Provisional application No. 60/319,906, filed on Jan. 27, 2003.

(51) Int. Cl. H04Q 1/00

(52) U.S. Cl. 340/5.91

(57) ABSTRACT

An electronic price display system has myriad price display labels. A mobile unit follows a path through the system, at one time or another along the path reaching sufficient proximity to each label to transmit power to it and thus to power it for the receipt of a message and to allow the label to acknowledge the message. The labels desirably do not rely upon battery power but have bistable regions providing homan-perceptible messages such as prices. The labels preferably are flexible and are pre-formed with a curvature well suited to standard grocery store shelf edge channels.

### CROSS REFERENCE TO RELATED APPLICATIONS

This application claims priority from U.S. Appl. No. 60/319,906 filed Jan. 27, 2003, which application is hereby incorporated herein by reference for all purposes.

### BACKGROUND OF INVENTION

The invention relates generally to display systems, and relates more particularly to electronic price display systems for retail stores.

Much time and attention have been spent in recent years in efforts to develop electronic price display systems. None of the approaches heretofore devised has seen commercial success. A chief problem with past approaches has been that of cost.

Nonrecurring cost associated with prior art price display systems includes the cost of the display labels. There is typically at least one label associated with each stockkeeping unit (SKU) within a store. Thus for a retail food store the number of labels may be thirty thousand or more. Clearly any reduction in cost of the label itself is commercially important due to the large number thereof.

Another nonrecurring cost is the installation cost for a system. In a wired system this includes labor and material costs for installing cabling throughout the store, to each shelf edge. The installation cost may also require placement of auxiliary rails (typically of plastic or metal) along all of the shelf edges, to receive the labels. The installation cost may also include labor and materials costs for mounting ceiling antennas for communication with labels or with transceivers wired to labels.

There are also recurring-cost issues associated with price display systems. In some prior-art systems each label is powered by a battery such as a lithium battery. The battery has a finite life and any label must be taken out of service and replaced as it reaches the end of its service life. For a battery-powered label a further concern is that the overall system design makes a big difference in the battery life. Transmit power from the label to other devices is one drain upon the energy budget. As is mentioned in U.S. Pat. No. 6,108,367 entitled “Low power two-way wireless communication system for electronic shelf labels” and in U.S. Pat. No. 6,130,603 entitled “Low-power RF-linked price display system,” a local oscillator required for a radio receiver is, if anything, a larger drain, because in a poorly designed system the receiver “on” time may greatly exceed the transmitter “on” time. In particular, if a label is required to be prepared to receive a message at any time, the label will need to activate its local oscillator for all the periods of time during which a message may arrive.

There is thus a great need for a display system in which nonrecurring costs are notably smaller than with prior-art systems.

### SUMMARY OF INVENTION

An electronic price display system has myriad price display labels. A mobile unit follows a path through the system, at one time or another along the path reaching sufficient proximity to each label to transmit power to it and thus to power it for the receipt of a message and to allow the label to acknowledge the message. The labels desirably do not rely upon battery power but have bistable regions providing homan-perceptible messages such as prices. The labels preferably are flexible and are pre-formed with a curvature well suited to standard grocery store shelf edge channels.

### BRIEF DESCRIPTION OF DRAWINGS

The invention will be described with respect to a drawing in several figures.

FIG. 1 is an interior view of a price display label.

FIG. 2 is an edgewise cross section of a shelf and shelf channel with a label.

FIG. 3 is a front view of a mobile unit.

FIG. 4.is a plan view of a store showing a route to be followed by a mobile unit.

FIG. 5 is a functional block diagram of electronics for the label.

FIG. 6 is a cross section of a label.

### DETAILED DESCRIPTION

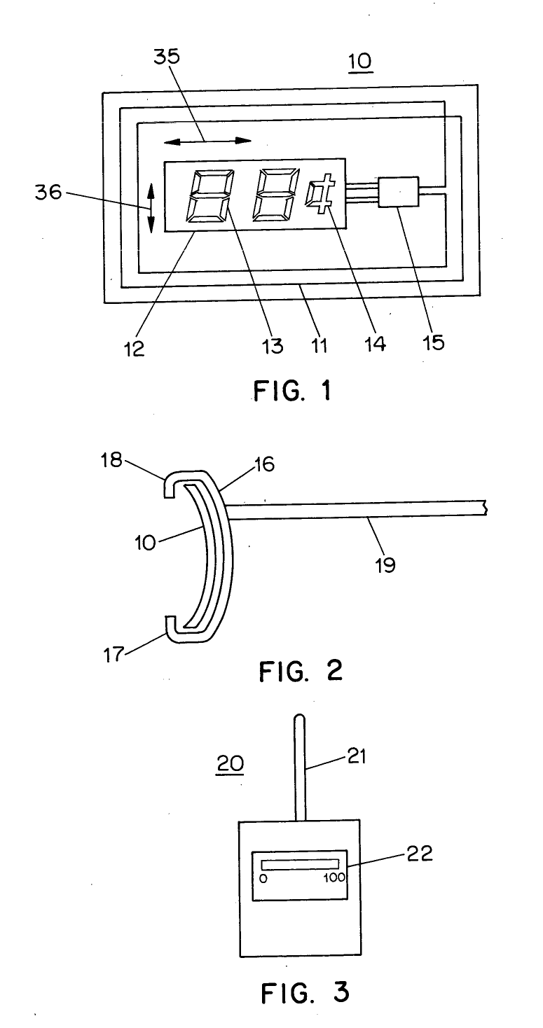

One embodiment of the invention, then, is a display system shown in FIG. 1 comprising a mobile unit 20 (FIG. 3) and myriad flexible displays 10. Each display comprises a display area 12 comprising a plurality of bistable regions 13, 14 each changeable between states, each region giving rise to at least two distinct visual conditions. Typically the regions comprise either segments (as shown in FIG. 1) or pixels. If they are segments, then the segments (typically seven in number) can form numerals. If they are pixels (typically in an array of at least 35 pixels) then the pixels can form numerals or alphabetic characters or special symbols such as cents, dollars, or euros, or symbols (e.g. virgules) used to connote unit pricing. Finally, some of the regions can be fully-formed symbols 14 such as cent or dollar or euro signs.

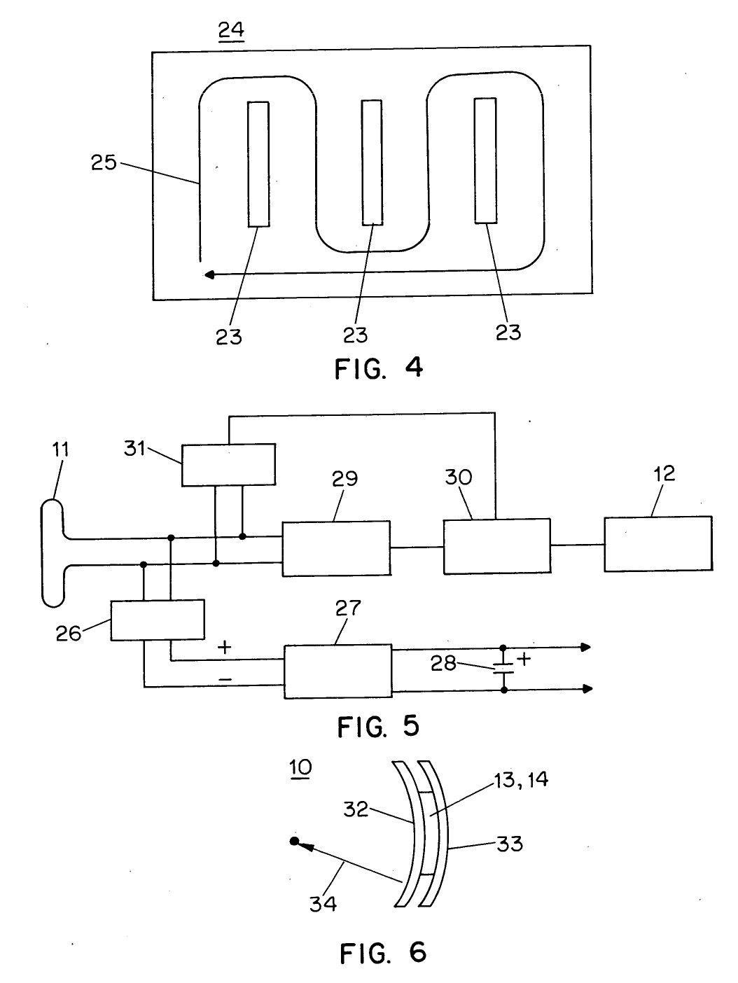

Each display further comprises an antenna 11 and an address decoding means 15 communicatively coupled to the antenna 11. The address decoding means for each display decoding an address that is unique with respect to other displays. The address decoder acts with respect to an address space defined for use within a display area such as a retail store 24 (FIG. 4). Typically the address space has substantially more addresses than the number of stock-keeping units (typically 30,000 or more) in the store. For convenience of manufacture and distribution of piece parts it may be preferable to use an address space that is far larger than the number of labels likely to be manufactured. In the latter case each label that is manufactured has an address distinct from any previously manufactured label and thus may be physically placed with any store without risk of duplicate addresses.

Desirably each display 10 is free from the need for a chemical power source such as a battery or voltaic cell, referred to collectively as batteries. Most batteries are rigid (inflexible) and are thus poorly suited for use in displays that are expected to be flexible. Most batteries are also sufficiently thick as to be poorly suited to thin displays. Finally, batteries have finite life, and thus the designer of a display system using batteries is forced to consider what happens when a battery runs out.

In a batteryless system, each display has the above-mentioned bistable regions 13, 14 which preserve a human-perceptible message even when no power is being provided to the display. The only time electric power is needed is when the display is communicating externally, for example with a mobile unit 20 (FIG. 3). In the inventive system the mobile unit 20 transmits RF energy to a label 10. The RF energy is received, rectified 26 (FIG. 5), regulated 27 (FIG. 5) and smoothed 28 (FIG. 5) to provide power for electronics 29, 30, 31 (FIG. 5). The electronics include the above-mentioned address decoder function 15 (FIG. 1). The electronics also preferably provide circuitry receiving data from the mobile unit 20, act upon the data by changing the bistable regions 13, 14 according to the data, and providing acknowledgment messages to the mobile unit 20. The acknowledgment messages may be accomplished by means of transmitter 31 (FIG. 5).

The rectification and regulation are readily accomplished by well-known semiconductor means 26, 27. Smoothing may be aided by a capacitor 28. Optionally a high-capacity capacitor may be employed not only for smoothing power for the electronics but also for maintaining states of the display regions depending on the technology used for the regions.

It should be appreciated that when a particular message intended for a particular label is sent from the mobile unit, the message may or may not reach the intended label. In many instances it will develop that the intended label is not in near enough proximity to the mobile unit for the label to be powered by the above-mentioned RF energy. Yet another occurrence is that interference may corrupt the message, such corruption detected by failure of a CRC checksum or failure in the nature of a framing error. In any such case the mobile unit will not receive an acknowledgment message and thus will know that it must try again at some future time.

Those skilled in the art will appreciate that any of a number of media and protocols might serve the needs of the system, including infrared, IEEE 802.11b, and Bluetooth, depending on power availability and power constraints.

Those skilled in the art will also appreciate that while the invention is described in an exemplary embodiment in which prices are displayed, the teachings of the invention permit displaying other types of information such as location, special price, number of product facings, and date of last price change. Optionally the data exchanges between the mobile unit and label may be password-protected to minimize the risk that a third party could change the label contents. The password used for this purpose is preferably updatable as needed.

Finally, one-important type of message is a mere data confirmation message which would not change anything on the display. The mobile unit may send a message to a label asking whether a particular register in the label contains particular contents. The label would check to see if there is a match between the expected and actual contents of the register and would provide a response indicative of whether the contents did or did not match, that is, indicating the results of a comparison. This permits detecting and correcting any incorrect contents, whether due to an unauthorized third-party change of data or due to some other event changing one or more bits in a label memory register.

It should also be appreciated that when the mobile unit transmits a single message intended for a particular label, it will often happen that hundreds of labels will be in near enough proximity to the mobile unit to receive enough RF power to activate the electronics. It will often happen that for nearly all of the powered labels, the address of the message does not match the label's address, in which case the balance of the message (the data) may be safely ignored.

Stated differently, the mobile unit 20 thus comprises a transceiver, the transceiver disposed to transmit an address signal and data signal communicating an address and data to displays. The mobile unit 20 has an antenna 21 and, preferably, a display 22 The antenna of each display is disposed, if the display is within an effective distance of the mobile unit, to receive electrical power as well as the address of the address signal and to communicate same to the address decoding means. The address decoding means of each display disposed, in the event of a match of the address of the address signal with the address of the display, to receive the data of the data signal, and to cause a change in at least one of the bistable regions thereof in response to the data.

The mobile unit may optionally be an automated motorized cart which travels in an automatic way along a route within a store. As discussed below, there may be some configurations and situations where there is a bandwidth limitation, that is, situations where if the mobile unit were moving too quickly, some labels might get lost and not be updated in a single pass along the router. In such situations a slowly moving automated cart may permit the system to do updating even with such a bandwidth limitation, where the cart may move more slowly than a human operator would tolerate.

A frequent sequence of events, then, is that an address and data signal are transmitted from the transceiver of the mobile unit. At a first display, the address and data signal are received and electrical power is derived therefrom. The electric power is applied to the address decoding means of the first display. The address decoding means is operated from the electrical power applied thereto and a determination is made whether there is a match between the address of the address signal and the address of the first display. The match may fail. Meanwhile, the address and data signal is received at a second display the and electrical power is also derived therefrom. The electrical power is applied to the address decoding means of the second display. The address decoding means of the second display is operated from the electrical power applied thereto and a determination is made whether there is a match between the address of the address signal and the address of the second display. This match may succeed, in which case the electronics causes a change in at least one of the bistable regions of the second display in response to the data.

It may also be appreciated that it can be quite helpful if the electronic price display is at least somewhat flexible. Such a display may comprise first and second flexible layers 32, 33, at least a portion of the first layer 32 being transparent to visible light. The display further comprises a plurality of bistable regions 13, 14 each changeable between states, each region giving rise to at least two distinct visual conditions, the regions disposed between the first and second layers and at least some of the regions disposed so as to be visible through the transparent portion of the first layer. The display further comprises electronic means 15 disposed between the first and second layers and connected with the bistable regions 13, 14 for causing the bistable regions to change between states. In such a display, the first flexible layer 32 is affixed to the second flexible layer 33 so that the display has a substantially cylindrical curvature with a radius of curvature 34 (FIG. 6) between one-half inch and two inches. The display thus may be substantially inflexible in one axis 36 (FIG. 1) and at least somewhat flexible in a different axis 35. To fit into a standard supermarket shelf edge channel 16 the display 10 needs to be capable of flexing so as to give rise to a cylinder with a horizontal axis 35 parallel to the long dimension of the channel 16. The shelf edge channel or rail 16 has top and bottom lips 17, 18 which can hold flexible price labels and the like.

In an exemplary embodiment, the first and second flexible layers are affixed to each other by adhesive. In another embodiment the first and second flexible layers are affixed to each other by means of ultrasonic welding. It will be appreciated that it is likely to be advantageous to form the display in its curved shape (rather than flat) so that when it is fitted into the shelf edge channel it is already of substantially the correct curvature to match the channel's curvature.

For some pricing applications in a store, the display can be flat (planar) and be backed by adhesive foam or other mounting means.

In many systems it will be quite unworkable to try to transmit with enough power to power all of the labels in a store. For example, government regulations and safety concerns may limit the desired transmit power of the mobile unit. It will thus be typical that when an address and data signal is transmitted from the transceiver, this will power more than one and less than all of the displays. It may also happen that a label for which a message is intended will not be among the powered labels. In such a case, the mobile unit is moved to a different location among the myriad electronic price displays, for example along a path 25 (FIG. 4). The message is transmitted for a second time from the transceiver, thereby powering address decoders of more than one and less than all of the displays, the displays having powered address decoders comprising at least one display that did not have a powered address decoder during the first transmission. If all goes well, at the at least one display having a powered address decoder, the message address matches the address of the display. In such a case, at least one of the bistable regions is changed in response to data in the address and data signal.

Bandwidth allocation may make a difference in the effective label-updating performance of the system. In one exemplary embodiment, any message transmitted by the mobile unit contains not only an address of a particular label but also contains the data to be received by that label. In such an embodiment it will be appreciated that an unsuccessful (that is, an unacknowledged) message will have occupied the communications channel for the duration of the entire message (i.e. address plus data). While the address portion cannot be omitted (else a label cannot determine whether or not it is a desired recipient of the message) the data portion of the message is not furthering the goals of the system and the time spent transmitting data might have been better allocated to an address of a subsequent message.

In another embodiment, address and data portions are sent separately. A first “probe” message is sent that contains little more than an address. If a matching label sends an acknowledgment, then the mobile unit sends a second message containing the data for that label (and perhaps also containing the entirety of the address as well). This approach reduces the bandwidth used up by failed messages, though at the expense of sending two messages where one might have served the goal of the system. Actual experimentation in particular working environments may find that one approach is preferable in some environments while the other is preferable in others.

If the mobile unit were to select randomly among its queued messages while transmitting, it will be appreciated that the ratio of the number of messages required to be transmitted to obtain acknowledgment for each of the messages may well be much greater than one. In a store where, say, ten mobile unit positions are needed to give power to each of the labels, it will be appreciated that the ratio may be five or more. Stated differently, to obtain acknowledgments from 30,000 labels it might be necessary to send 150,000 or more messages, where a substantial majority of messages fail.

This provides motivation to devise other measures which may help to reduce the number of failed messages. For example, it may be possible to arrange for the mobile unit to follow the same path through the store repeatedly. Experience will permit accumulating information as to which labels tend to follow others in the sequence. The mobile unit can then refrain from trying to send messages to labels that are likely to fail based upon the progress of the mobile unit through the path. This approach may offer its benefits for a path covering the entire store or may be applied to portions of the path such as particular single aisles of the store.

Another approach is to permit the mobile unit to infer its position. This may be by GPS positioning or by ranging to fixed points through ultrasound pinging. The mobile unit may also infer its position simply by making note of the labels for which it has received acknowledgments lately. With any of these position inferences the mobile unit can select from among its queue of messages for messages that are less likely to fail based upon the inferred position.

In a typical sequence of events, the mobile unit will be loaded from a host computer, with a queue of messages that are desired to be transmitted. This may include price updates for a store. In the store 24 (FIG. 4) there are gondolas 23 which carry shelves 19 (FIG. 2) thus defining aisles. A store employee will “walk” the mobile unit up and down each aisle of the store for example along path 25 (FIG. 4), and ideally after the entire store 24 has been traversed the queue will have been completely satisfied, with an acknowledgment for each message of the queue. The mobile unit may optionally show a “progress gauge” 22 (FIG. 3) showing the percentage of messages that have been acknowledged, so that if there is some systemic problem (e.g. a broken antenna at the mobile unit) the employee will know of the problem early in the process.

It may well happen that even after a complete store path walk, one or more of the queued messages fails, that is, that no acknowledgment is received. This could happen because of radio interference at the time of the message to the nonresponsive label. Alternatively it could happen because a label has been mechanically damaged or removed, for example due to vandalism. In such a case the employee may receive a message (from the host or from the mobile unit) advising of the failure. The message may recommend simply walking the store again (especially if there are many failed messages) or may recommend going to the particular location of the label that did not respond. This may prompt installing a replacement label if it has been damaged or removed.

While the invention is described with respect to particular embodiments, it should be appreciated that the invention is not so limited. Those skilled in the art will have no difficulty devising many obvious variants and improvements of the invention which do not depart from it. The invention is thus encompassed by the full scope of the claims which follow.

1. A display system comprising a mobile unit and myriad flexible displays,
each display comprising a plurality of bistable regions each changeable between states, each region giving rise to at least two distinct visual conditions,
each display further comprising an antenna and an address decoding means communicatively coupled to the antenna;
the address decoding means for each display decoding an address that is unique with respect to other displays;
the mobile unit comprising a transceiver, the transceiver disposed to transmit an address signal and data signal communicating an address and data to displays;
the antenna of each display disposed, if the display is within an effective distance of the mobile unit, to receive electrical power as well as the address of the address signal and to communicate same to the address decoding means;
the address decoding means of each display disposed, in the event of a match of the address of the address signal with the address of the display, to receive the data of the data signal,
and to cause a change in at least one of the bistable regions thereof in response to the data.

2. A display system comprising a mobile unit and myriad displays each lacking a battery,
each display comprising a plurality of bistable regions each changeable between states, each region giving rise to at least two distinct visual conditions,
each display further comprising an antenna and an address decoding means communicatively coupled to the antenna;
address decoding means for each display decoding an address that is unique with respect to other displays;
the mobile unit comprising a transceiver, the transceiver disposed to transmit an address signal and data signal communicating an address and data to displays;
the antenna of each display disposed, if the display is within an effective distance of the mobile unit, to receive electrical power as well as the address of the address signal and to communicate same to the address decoding means;
the address decoding means of each display disposed, in the event of a match of the address of the address signal with the address of the display, to receive the data of the data signal,
and to cause a change in at least one of the bistable regions thereof in response to the data.

3. A method for use with a display system comprising a mobile unit and myriad displays, each display comprising a plurality of bistable regions each changeable between states, each region giving rise to at least two distinct visual conditions, each display further comprising an antenna and an address decoding means communicatively coupled to the antenna; the mobile unit comprising a transceiver, the method comprising the steps of:
transmitting from the transceiver of the mobile unit an address and data signal;
receiving at a first display the address and data signal and deriving electrical power therefrom;
applying the electrical power to the address decoding means of the first display;
operating the address decoding means of the first display from the electrical power applied thereto and determining whether there is a match between the address of the address signal and the address of the first display;
determining within the address decoding means of the first display that there is no match; at a second display the address and data signal and deriving electrical power therefrom;
applying the electrical power to the address decoding means of the second display;
operating the address decoding means of the second display from the electrical power applied thereto and determining whether there is a match between the address of the address signal and the address of the second display;
determining within the address decoding means of the second display that there is a match; and
causing a change in at least one of the bistable regions of the second display in response to the data.

4. An electronic price display comprising first and second flexible layers, at least a portion of the first layer being transparent to visible light,
the display further comprising a plurality of bistable regions each changeable between states, each region giving rise to at least two distinct visual conditions, the regions disposed between the first and second layers and at least some of the regions disposed so as to be visible through the transparent portion of the first layer;
the display further comprising electronic means disposed between the first and second layers and connected with the bistable regions for causing the bistable regions to change between states;
the display further characterized in that the first flexible layer is affixed to the second flexible layer so that the display has a substantially cylindrical curvature with a radius of curvature between one-half inch and two inches.

5. The display of claim 4 wherein the first and second flexible layers are affixed to each other by adhesive.

6. The display of claim 4 wherein the first and second flexible layers are affixed to each other by means of ultrasonic welding.

7. An updating method for use with a mobile unit having a transceiver and myriad electronic price displays each having an address decoder and a respective address and having a plurality of bistable regions each region showing at least two visual conditions, the method comprising the steps of:
transmitting for a first time an address and data signal from the transceiver, the address and data signal comprising a first address, thereby powering address decoders of more than one and less than all of the displays;
receiving, at one of the displays having a powered address decoder, the first address, the first address not matching the respective address of the display;
moving the mobile unit to a different location among the myriad electronic price displays;
transmitting for a second time the address and data signal from the transceiver, the address and data signal comprising the first address, thereby powering address decoders of more than one and less than all of the displays, the displays having powered address decoders comprising at least one display that did not have a powered address decoder during the first transmission;
receiving, at the at least one display, having a powered address decoder, the first address, the first address matching the respective address of the display, and changing at least one of the bistable regions in response to data in the address and data signal.

8. An updating method for use with a mobile unit having a transceiver and myriad electronic price displays each having an address decoder and a respective address and having a plurality of bistable regions each region showing at least two visual conditions, the method comprising the steps of:
an address signal from the transceiver, the address signal comprising a first address, thereby powering address decoders of more than one and less than all of the displays;
receiving, at one of the displays having a powered address decoder, the first address, the first address matching the respective address of the display;
transmitting a second signal from the one of the displays and receiving the signal at the transceiver;
in response to the second signal, transmitting a data signal from the transmitter, and receiving it at the one of the displays; and
changing at least one of the bistable regions of the one of the displays in response to data in the data signal.

9. A method for use with a display system comprising a mobile unit and myriad displays, each display comprising a plurality of bistable regions each changeable between states, each region giving rise to at least two distinct visual conditions, each display further comprising an antenna and an address decoding means communicatively coupled to the antenna; the mobile unit comprising a transceiver, the method comprising the steps of:
transmitting from the transceiver of the mobile unit an address and data signal;
receiving at a first display the address and data signal and deriving electrical power therefrom;
applying the electrical power to the address decoding means of the first display;
operating the address decoding means of the first display from the electrical power applied thereto and determining whether there is a match between the address of the address signal and the address of the first display;
within the address decoding means of the first display that there is no match;
receiving at a second display the address and data signal and deriving electrical power therefrom;
applying the electrical power to the address decoding means of the second display;
operating the address decoding means of the second display from the electrical power applied thereto and determining whether there is a match between the address of the address signal and the address of the second display;
determining within the address decoding means of the second display that there is a match;
comparing the data with contents of a memory of the second display; and
communicating a message from the second display indicative of the results of the comparison.
